(19) United States
(12) Patent Application Publication
(10) Pub. No.: US 2006/0120839 A1
(43) Pub. Date: Jun. 8, 2006

(54) Apparatus and method for successively emptying containers filled with articles

(75) Inventor: Michael Knabe, Geesthacht (DE)

Correspondence Address: VENABLE LLP, P.O. BOX 34385, WASHINGTON, DC, 20045-9998, US

(73) Assignee: Hauni Maschinenbau AG, Hamburg (DE)

(21) Appl. No.: 11/272,343

(22) Filed: Nov. 14, 2005

(30) Foreign Application Priority Data
Nov. 12, 2004 (DE) 10 2004 055 629.6

(51) Int. Cl. B65G 65/04

(52) U.S. Cl. 414/403

(57) ABSTRACT

The invention concerns an apparatus for successively emptying containers filled with articles, including a delivery element for delivering full containers to a transfer device, whereby the transfer device is designed as a pivot device which includes a pivot arm with a receptacle arranged at a free end and is pivotable about a pivot axis for pivoting out of a lower receiving position A into an upper emptying position E and back, as well as a removal element for removing the empty containers, which is distinguished by the fact that the receptacle at the free end has at least two chambers for receiving at least two containers. Furthermore the invention concerns a method in which, at the same time as emptying the container in the emptying position E, a container already emptied beforehand is introduced into the receptacle, and the empty container after pivoting back into the receiving position A is removed from the receptacle again, while at the same time a full container is introduced into the receptacle.

### CROSS-REFERENCE TO RELATED APPLICATION

This application claims the priority of German Patent Application No. 10 2004 055 629.6 filed Nov. 12, 2004, the subject matter of which is incorporated herein by reference. The disclosure of all U.S. and foreign patents and patent applications mentioned below are also incorporated herein by reference.

### BACKGROUND OF THE INVENTION

The invention concerns an apparatus for successively emptying containers filled with articles, including a delivery element for delivering full containers to a transfer device, whereby the transfer device is designed as a pivot device which includes a pivot arm with a receptacle arranged at a free end and which is designed to be pivotable about a pivot axis for pivoting out of a lower receiving position A into an upper emptying position E and back, as well as a removal element for removing the empty containers. Furthermore, the invention concerns a method for successively emptying containers filled with articles, including the steps of: delivering containers filled with articles into the region of a transfer device, receiving a full container in a receptacle of the transfer device, which transfer device is designed as a pivot device, pivoting the full container out of a receiving position A into an emptying position E, and emptying the container.

Apparatuses and methods of this kind are used in particular when processing rod-shaped articles in the tobacco-processing industry. Thus e.g. filter rods, tobacco sticks, cigarettes or the like are put in containers and kept in them for storage and/or further processing or conveyed to subsequent apparatuses, e.g. magazines, intermediate magazines, packing machines or the like. For automated delivery of the articles out of the containers, which are also called trays, into the magazines, intermediate magazines or direct into packing machines or the like, the containers must be emptied and the empty containers removed again. For this purpose the containers are collected from a receiving position A and pivoted into an emptying position E, so that the articles fall out of the container which is open or to be opened on at least one side. Then the emptied containers are pivoted back into the receiving position, where they are removed so that a full container can then be received again.

Such apparatuses for the method described above are known e.g. from EP 1 086 628 A2. The apparatus described therein discloses a pivot device as a transfer device. The pivot device includes a pivot arm which has a receptacle at a free end. This receptacle, which is also referred to as a frame, is designed for receiving a container. The pivot device is pivotable about a pivot shaft by means of which a full container can be conveyed out of a lower receiving position A into an upper emptying position E and back.

The known apparatuses and methods, however, have the drawback that they take a considerable amount of time for emptying and return of the emptied containers. To put it another way, the reception of a new full container is blocked as long as the previously full container to be emptied is not fully emptied. In other words, the one full container must first be completely emptied before it can be pivoted by the pivot device back down into the receiving position. Only after discharge of the empty container to a subsequent removal device is the receptacle then again ready to receive a new full container.

### SUMMARY OF THE INVENTION

It is therefore the object of the present invention to provide an apparatus which ensures quick and easy emptying of the containers on the one hand and quick return of already emptied containers on the other hand. Furthermore, it is the object of the present invention to allow an easy and quick method for emptying and returning containers.

This object is achieved by an apparatus of the kind mentioned hereinbefore by the fact that the receptacle at the free end has at least two chambers for receiving at least two containers. Due to this design, the time for emptying the full containers and returning the emptied containers on the one hand and taking out the empty containers and introducing the full containers into the receptacle can be shortened, because an empty container can already be returned again during emptying of a full container on the return path, that is, during the pivot movement from the emptying position E into the receiving position A. When the empty container in the receiving position is taken out of one chamber, already a full container can be guided into the other chamber again. The number of container changes per minute increases considerably as a result. Furthermore, additional transfers can be avoided.

Preferably, one chamber is designed to receive and discharge a full container, and one chamber to receive and discharge an empty container. Hence simultaneous reception and discharge of two containers at one position, namely the receiving position A or the emptying position E, is possible in a particularly easy and quick manner.

Advantageously, one of the chambers can be filled and emptied in a substantially vertical direction, and the other chamber can be emptied and filled in a substantially horizontal direction. This means that at one position A or E one container is moved horizontally and one container vertically, simultaneously, whereby emptying means not emptying of the articles out of the container, but taking the container out of the chamber. This design allows very short transport paths of the containers into the chambers and out of the chambers, which substantially shortens the waiting times between the pivot movements from position A to E and vice versa.

In a preferred embodiment, above the receptacle in the emptying position E is arranged a storage means for empty containers. This ensures that an empty container is always returned with the pivot device during each pivot movement out of position E to A, so that “idle journeys” of the pivot device are avoided.

Furthermore, the object is achieved by a method with the steps mentioned hereinbefore by the fact that, at the same time as emptying the container in the emptying position E, a container already emptied beforehand is introduced into the receptacle, and the empty container after pivoting back into the receiving position A is removed from the receptacle again, while at the same time a full container is introduced into the receptacle. Hence the advantages of quick and easy emptying of the containers and return thereof already described above are achieved.

Preferably, a full container located in the emptying position E is first moved completely out of the receptacle before the container is then emptied. Hence the pivot device can already be started for discharging an empty container and receiving a full container, while actual emptying of the container previously moved into the emptying position E takes place. This again leads to a saving of time.

### BRIEF DESCRIPTION OF THE DRAWINGS

Further advantageous and preferred characteristics and method steps are apparent from the subsidiary claims and the description. A particularly preferred embodiment as well as the principle of the method are explained in more detail with the aid of the attached drawings. The drawings show:

FIG. 1 a side view of an apparatus according to the invention with a two-chamber receptacle, and

FIG. 2 a front view of the apparatus as in FIG. 1.

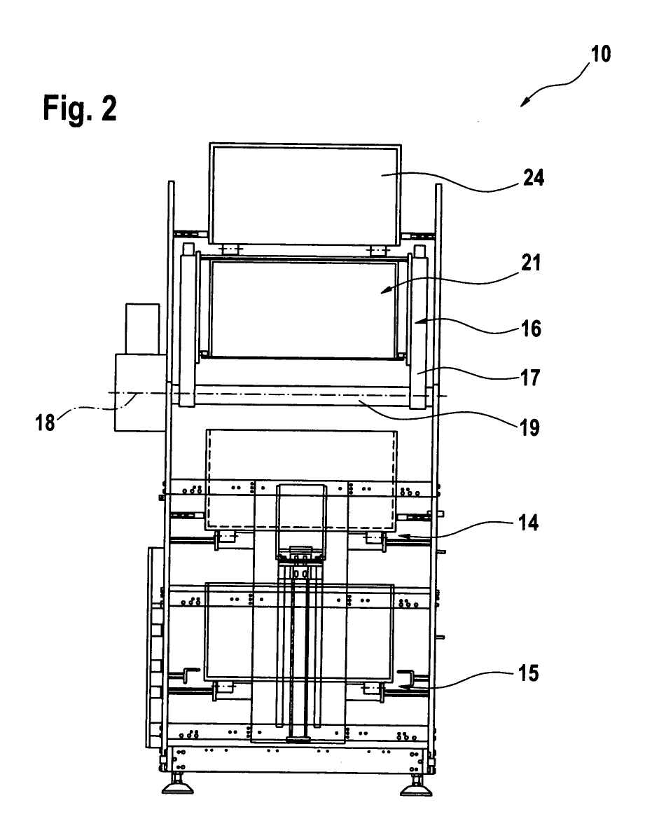

### DETAILED DESCRIPTION OF THE INVENTION

The apparatuses shown are used for automated emptying of containers filled with filter rods, cigarettes or the like, on packing machines or the like.

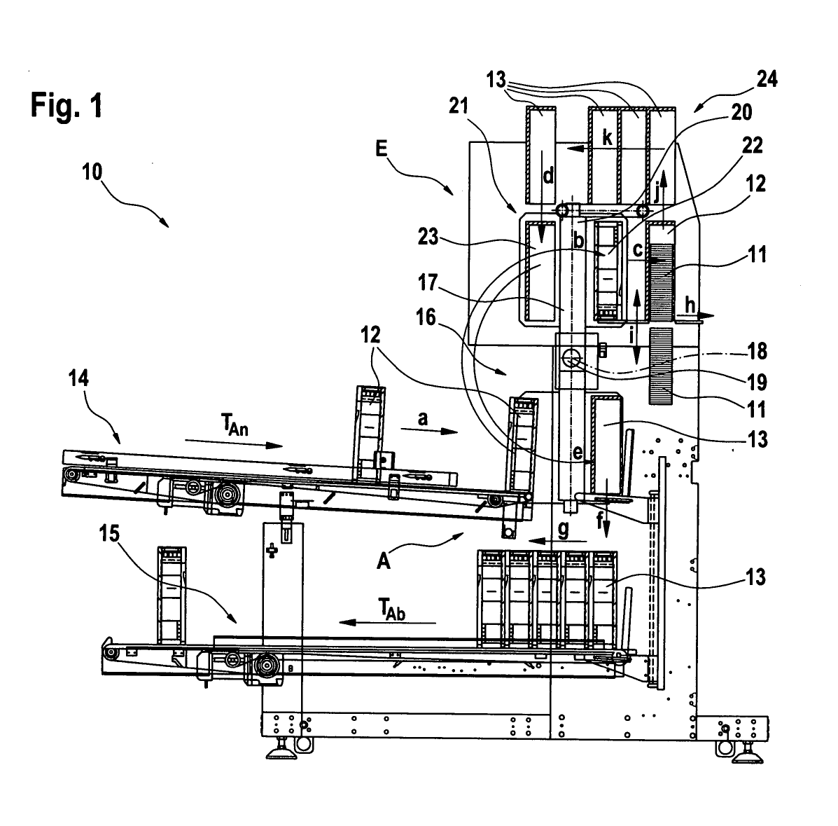

FIG. 1 shows an apparatus 10 for successively emptying containers 12 filled with articles 11. In the filled state, the containers 12 are also referred to as full containers. Emptied containers 13 are accordingly referred to as empty containers. The apparatus 10 includes a delivery element 14 for the full containers and a removal element 15 for the empty containers. The removal element 15 is arranged below the delivery element 14. Both the removal element 15 and the delivery element 14 in this embodiment are designed as endless conveyor belts and are driven intermittently or continuously by suitable drive means. The directions of driving are opposed. The containers 12 are transported in the direction of approach T_{An} into the region of a transfer device 16, and the containers 13 are transported in the direction of discharge T_{Ab} away from the transfer device. The transfer device 16 is designed as a pivot device and has a pivot arm 17. The pivot arm 17 is arranged in the region of a shaft 19 so as to be pivotable about a pivot axis 18. At the free end 20 of the pivot arm 17 is arranged a receptacle 21. The receptacle 21 has at least two chambers 22, 23, whereby one chamber 22 is designed for receiving and discharging a full container 12, and the other chamber 23 for receiving and discharging an empty container 13. The pivot arm 17 is pivotable out of a lower receiving position A into an upper emptying position E and back.

The chambers 22, 23 are designed and arranged in relation to each other in such a way that simultaneously one chamber, namely chamber 22, can receive a full container 12 and the other chamber 23 can discharge an empty container 13, and vice versa. The receptacle 21 or its chambers 22, 23 in addition also serve as a frame for receiving the containers 12, 13, whereby the frames are adapted to the container geometry and container design. Usually the containers 12, 13 are cuboid with broad sides, namely one open front side and a rear wall, as well as with narrow sides, namely the side walls. Other containers are conceivable too, in which front and/or rear and/or side walls are open or to be opened. Within the frames are provided corresponding means, namely e.g. clamping devices or the like, for the containers 12, 13, which serve to fix the articles in the full containers 12 or to fix the containers 12, 13 in the chambers 22, 23 during the pivot movement.

However, the frames or chambers 22, 23 lack individual wall elements for receiving and discharging the containers 12, 13. Thus in the embodiment shown the chamber 22 is designed to receive and discharge the full containers 12 with open broad side, e.g. Wilt no front wall. The side facing towards the delivery element 14 in the receiving position A is referred to as the front wall. The chamber 23 is open or to be opened on at least one narrow side, namely e.g. the lower side, also referred to the receiving position A. With this design, the chamber 22 can be filled and emptied in a substantially horizontal direction, and the chamber 23 in a substantially vertical direction.

The delivery element 14 is, as already mentioned above, arranged above the removal element 15. The two elements 14, 15 are, however, arranged slightly offset from each other. This means in the embodiment shown that the removal element 15 in the direction of approach T_{An} extends beyond the delivery element 14 and ends below the receiving position A, such that the removal element 15 can be at least partially preferably provided with empty containers 13 from above. In the region of the receiving position A, on the one hand the (substantially horizontal) reception of full containers 12 direct from the delivery element 14 takes place. On the other hand, in the region of the receiving position A the (substantially vertical) discharge of empty containers 13 onto the removal element 15 takes place.

Above the emptying position E, in the region of the receptacle 21 is arranged a storage means 24 for empty containers 13. The storage means 24 is designed as a conveyor belt. Furthermore, in the region of the emptying position E are provided means for removing full containers 12 from the chamber 22, means for conveying the containers 13 which have been completely emptied outside the chamber 22 into the storage means 24, and means for conveying the empty containers 13 out of the storage means 24 into the chamber 23. These means can be gripping elements, hydraulic and/or pneumatic cylinder systems, linear units or otherwise common devices for fixing, transporting, etc.

The method is described in more detail below with the aid of FIG. 1.

By means of the delivery element 14, full containers 12 are conveyed in the direction of approach T_{An} (see arrow a). The pivot device or the receptacle 21 thereof is located in the lower receiving position A. A full container 12 is introduced into the receptacle 21 or, to be more precise, the chamber 22, and fixed in the chamber 22. If necessary, the container 12 is secured to the effect that no articles 11 fall out of the container 12. This can be done e.g. by a closure plate similar to a slide bottom or the like. Then the pivot arm 17 pivots about the pivot axis 18 into the upper emptying position E (see arrow b). As soon as the receptacle 21 has reached the emptying position E, the full container 13 is conveyed in a horizontal direction (see arrow c) out of the chamber 22, this being into a so-called intermediate station out of which the full container 12 is then moved into the actual emptying position and emptied there.

At the same time as conveying the full container 12 out of the chamber 22 (see arrow c), a previously emptied container 13 is moved out of the storage means 24 from above in a vertical direction into the chamber 23 (see arrow d). This can be achieved by force of gravity, a linear unit or otherwise. As soon as the empty container 13 is located in the chamber 23, the pivot arm 17 pivots out of the upper position E into the lower position A (see arrow e). In this position a new full container 12 is moved into the chamber 22 (see arrow a). At the same time the empty container 13 is moved out of the chamber 23 in a vertical direction downwards onto the removal element 15 (see arrow f). As soon as the operation of filling and emptying the containers 12, 13 in position A is over, the pivot arm 17 pivots into position E again.

The empty containers 13 are discharged by the removal element 15 in the direction of discharge T_{Ab} (see arrow g). The step sequence a to g is repeated as often as desired. So that this can also take place in the manner described, the full containers 12 are, after they have left the chamber 22 in the upper position, emptied in the emptying station. For this purpose the containers 12 are opened (see arrow h), by e.g. pulling a flap, so that the articles 11 usually drop out of the container 12 by force of gravity (see arrow i). When the containers 12 are completely emptied, the then empty containers 13 are moved e.g. by means of a linear unit in a vertical direction upwards into the storage means 24 (see arrow j). In the storage means 24 the empty containers 13 are moved in the direction opposite the direction of approach T_{An} into a position (see arrow k) out of which they can be moved downwards into the empty chamber 23.

What is claimed is:

1. Apparatus for successively emptying containers filled with articles, including a delivery element for delivering full containers to a transfer device, whereby the transfer device is designed as a pivot device which includes a pivot arm with a receptacle arranged at a free end and is pivotable about a pivot axis for pivoting out of a lower receiving position A into an upper emptying position E and back, as well as a removal element for removing the empty containers, characterized in that the receptacle at the free end has at least two chambers for receiving at least two containers.

2. Apparatus according to claim 1, characterized in that one chamber is designed to receive and discharge a full container, and one chamber to receive and discharge an empty container.

3. Apparatus according to claim 1, characterized in that the two chambers are designed and arranged in relation to each other in such a way that simultaneously one chamber can receive a full container and the other chamber can discharge an empty container, and vice versa.

4. Apparatus according to claim 1, characterized in that one of the chambers can be filled and emptied in a substantially vertical direction, and the other chamber can be emptied and filled in a substantially horizontal direction.

5. Apparatus according to claim 4, characterized in that one chamber has on at least one broad side an opening for receiving and discharging a container, and the other chamber has on at least one narrow side an opening for receiving and discharging a container.

6. Apparatus according to claim 1, characterized in that in the region of the emptying position E is formed an intermediate station for receiving the still full containers which have been conveyed out of the chamber.

7. Apparatus according to claim 1, characterized in that the delivery element and the removal element are arranged one above the other.

8. Apparatus according to claim 1, characterized in that above the receptacle in the emptying position E is arranged a storage means for empty containers.

9. Method for successively emptying containers filled with articles, including the steps of:
delivering containers filled with articles into the region of a transfer device,
receiving a full container in a receptacle of the transfer device, which is designed as a pivot device, p1 pivoting the full container out of a receiving position A into an emptying position E, and
emptying the container,
characterized in that
at the same time as emptying the container in the emptying position E, a container already emptied beforehand is introduced into the receptacle, and the empty container after pivoting back into the receiving position A is removed from the receptacle again, while at the same time a full container is introduced into the receptacle.

10. Method according to claim 9, characterized in that a full container located in the emptying position E is first moved completely out of the receptacle before the container is then emptied.

11. Method according to claim 9, characterized in that in the receiving position A a full container is moved into a first chamber of the receptacle, while at the same time an already emptied container is taken out of a second chamber of the receptacle, and in the emptying position E the full container is moved out of the chamber, while at the same time an empty container is moved into the chamber.

12. Method according to claim 11, characterized in that the full containers are introduced into and taken out of the chamber in a substantially horizontal direction.

13. Method according to claim 11, characterized in that the empty containers are introduced into and taken out of the chamber in a substantially vertical direction.

14. Method according to claim 9, characterized in that the emptied containers after emptying into a storage means and then if necessary out of the storage means are moved again into the receptacle.
